(19) United States
(12) Patent Application Publication
(10) Pub. No.: US 2024/0241574 A1
(43) Pub. Date: Jul. 18, 2024

(54) BEHAVIOR TRANSFORMATION SUPPORT METHOD, BEHAVIOR TRANSFORMATION SUPPORT APPARATUS AND PROGRAM

(71) Applicant: NIPPON TELEGRAPH AND TELEPHONE CORPORATION, Tokyo (JP)

(72) Inventors: Reiko ARUGA, Tokyo (JP); Naoto ABE, Tokyo (JP)

(21) Appl. No.: 18/558,444

(22) PCT Filed: May 13, 2021
(86) PCT No.: PCT/JP2021/018180

§ 371 Date: Nov. 1, 2023

(51) Int. Cl. G06F 3/01

(52) U.S. Cl. CPC G06F 3/011; G06F 2203/011

(57) ABSTRACT

A computer executes a detection procedure of recording information on a resource in a storage unit when detecting use of the resource that can be utilized for supporting behavior change of a user based on sensing data, an estimation procedure of estimating a spatial or temporal approach of a user to the resource indicated by the information recorded in the storage unit based on the sensing data, and an output procedure of outputting a message corresponding to the resource whose approach is estimated by the estimation procedure, thereby improving the efficiency of behavior change support.

### TECHNICAL FIELD

The present invention relates to a behavior change support method, a behavior change support device, and a program.

### BACKGROUND ART

There is provided a service for notifying a user of advice for prompting the user to perform a behavior for health from a smart phone, a smart watch, or the like.

For example, there is a service that captures the timing of a strong stress state and encourages a user to take a deep breath (NPL 1 and NPL 2), and a service that encourages a user to stand up and move the user's body if the user has been sitting for a long time (NPL 3).

However, if the timing of notification of advice is inappropriate for the context of the user's behavior, such as receiving advice “You have been sitting for a long time. Let's get up and stretch” during a meeting, behaviors according to advice (recommended behaviors) are not put into practice.

In view of this, a system has been proposed which presents information matching the context of the behavior of the user by sensing the environment of the user (PTL 1).

The recommended behavior is notified in accordance with the context of the user's behavior, thereby increasing the rate of practice of the recommended behavior, which becomes a habit, and there is a possibility of causing behavior change.

### CITATION LIST

### Patent Literature

PTL 1 Japanese Patent Application Publication No. 2019-185389

### Non Patent Literature

NPL 1 MLTsports, “GARMIN health management vol. 1”, [online], Internet <URL: https://mlt.jpn.com/garmin-healthcare-vol-1/>
NPL 2 GARMIN, [online] Internet <URL: https://www.garmin.co.jp/products/wearables/vivomove-hr-rose-gold-white/>
NPL 3 “Close your rings,” [online], Internet <URL: https://www.apple.com/jp/watch/close-your-rings/>

### SUMMARY OF INVENTION

### Technical Problem

However, even if the notification timing is appropriate, if the notification content is a content which cannot be practiced by the user's life environment or lifestyle, it cannot be expected to be put into practice.

For example, even if a user is notified of the recommended behavior for exercise during the lunch break of a working day, “Let's use the stairs during the lunch break,” it is difficult to put a behavior corresponding to the advice into practice if there are no stairs available in the office or the vicinity of the office of the user.

Also, even if the recommended dietary behavior “avoid fried foods for lunch today” is notified at the start of the lunch break, when the user brings a lunch box or purchases lunch at a store at the time of commuting, since the meal content has already been decided, it is difficult to change meal contents.

In order to increase the practice rate of recommended behaviors, it is necessary for the system to grasp beforehand resources (life information) which can be utilized for supporting the behavior change such as the life environment and the lifestyle of the user, but it is inefficient for answers to be given to these questions in the form of an inquiry.

The present invention has been made in view of the above-mentioned problems, and an object thereof is to improve the efficiency of behavior change support.

### Solution to Problem

In order to solve the above problem, a computer executes a detection procedure of recording information on a resource in a storage unit when detecting use of the resource that can be utilized for supporting behavior change of a user based on sensing data, an estimation procedure of estimating a spatial or temporal approach of a user to the resource indicated by the information recorded in the storage unit based on the sensing data, and an output procedure of outputting a message corresponding to the resource whose approach is estimated by the estimation procedure.

### Advantageous Effects of Invention

The efficiency of the behavior change support can be improved.

### BRIEF DESCRIPTION OF DRAWINGS

FIG. 1 is a diagram illustrating an example of the behavior of the value of the acceleration sensor when the elevator is lifted or lowered.

FIG. 2 is a diagram illustrating an example of a behavior of a value of an atmospheric pressure sensor when an escalator is lowered.

FIG. 3 is a diagram illustrating a hardware configuration example of a user terminal 10 according to a first embodiment.

FIG. 4 is a diagram illustrating a hardware configuration example of a user terminal 10 according to the first embodiment.

FIG. 5 is a flowchart for illustrating an example of a processing procedure executed by the user terminal 10 in a life information registration phase.

FIG. 6 is a diagram illustrating a configuration example of a life information storage unit 16 according to the first embodiment.

FIG. 7 is a flowchart for illustrating an example of a processing procedure executed by the user terminal 10 in a recommended behavior presentation phase.

FIG. 8 is a diagram illustrating a configuration example of a message list storage unit 17 according to the first embodiment.

FIG. 9 is a diagram illustrating a configuration example of a life information storage unit 16 according to a second embodiment.

FIG. 10 is a diagram illustrating a configuration example of a message list storage unit 17 according to the second embodiment.

### DESCRIPTION OF EMBODIMENTS

In each of the following embodiments, an example will be described in which life information that can be utilized for supporting behavior change (behavior change support) such as a life environment and a lifestyle of a user is ascertained in advance by sensing, and a recommended behavior is presented based on the life information.

Embodiments of the present invention will be described below with reference to the drawings.

### First Embodiment

A first embodiment is an embodiment relating to presentation of a message to increase user activity amount.

Compared to flat places, activities on stairs and slopes increase the activity amount. Stairs and slopes are considered as resources which can be utilized to increase the activity amount.

In addition, when the number of steps is increased, the activity amount is increased. As a resource which can be utilized to increase the number of steps, a stop position of mobility is considered. Parking a vehicle or a bicycle at a place far from the entrance of a building in a parking lot is a method for increasing the number of steps without greatly changing the behavior of daily life.

Hereinafter, resources that can be utilized for behavior change support such as use of stairs, slopes, mobility aids, or the like, that is, increasing the activity amount, are referred to as “behavior change support resources.”

### <Utilization of Stairs and Slopes>

Use of an elevator and an escalator in public transportation or an office is detected from positional information of an atmospheric pressure sensor and an acceleration sensor built into a smart phone or the like of a user and GPS.

As corresponding advice, when a user approaches a point where the use of an elevator or an escalator was detected in the past or during the lunch break while the user is in the office, a message such as “If there are stairs nearby, why don't you use them today?” is presented to increase the opportunities for use of stairs.

A staying time in the office can be estimated from the staying time in the daytime, GPS data, or the like.

Also, an atmospheric pressure sensor built into a smart phone or the like detects that there is a slope on a road usually used such as a commuting route.

As corresponding advice, when it is detected immediately before going to a slope from GPS data or the like, a message for increasing the activity amount is presented in the form of “Would you like to walk briskly on a slope today?”

Similarly, the presence of stairs in the house is detected from an atmospheric pressure sensor built into a smartphone or the like.

As the corresponding advice, a message for increasing opportunities to go up and down stairs such as “If you have to carry laundry to the second floor, divide it into two and carry it in two parts” is presented.

The stay in the home can be estimated from the staying time at night and GPS data or the like.

The use of elevators, escalators, stairs, and slopes is detected by, for example, the following means.

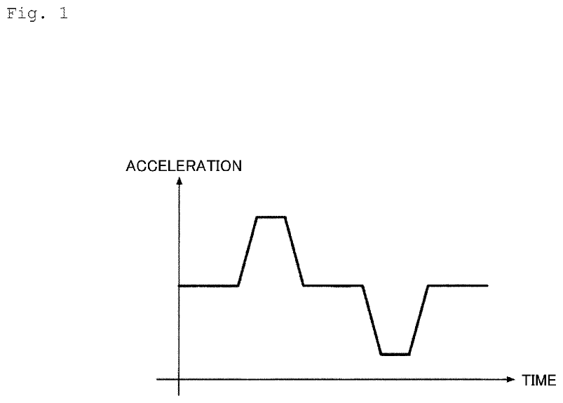

Since the value of the acceleration sensor mounted on the smart phone or the like behaves as illustrated in FIG. 1 when the elevator moves up and down, the use of the elevator is detected by recognizing these patterns.

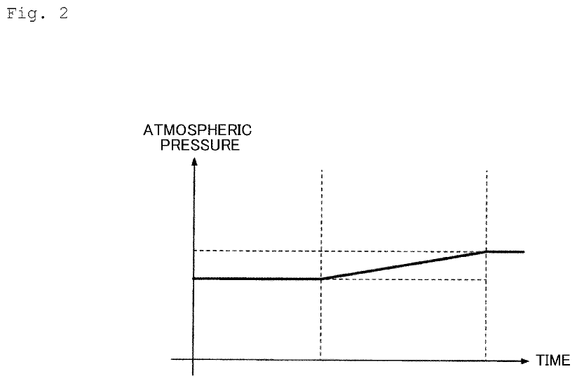

In addition, when the escalator is lowered, the value of the atmospheric pressure sensor mounted on the smart phone or the like behaves as illustrated in FIG. 2, and the acceleration sensor takes a constant value, so that the use of the escalator is detected by recognizing these patterns.

Also when the user goes down a slope, the value of the atmospheric pressure sensor behaves as illustrated in FIG. 2, but the value of the acceleration sensor changes with the period of walking, and walking on the slope is detected based on such a pattern.

Even when going down stairs, the value of the atmospheric pressure sensor behaves in the same way as in FIG. 2, but when using the stairs, the value of the acceleration sensor changes in a cycle different from the cycle of ordinary walking due to the relation of the depth of the stairs, and the walking of the stairs is detected by using GPS data.

### <Utilization of Stop Position of Mobility>

By obtaining positional information and moving speed information from the GPS data, the use of an automobile and a motorcycle is detected.

As corresponding advice, when starting driving of a vehicle or a motorcycle, a message that encourages an increase in the number of steps, such as “Would you like to park your vehicle or motorcycle in a parking lot farther away from the building today?” is presented.

Similarly, the use of the bicycle is detected.

As corresponding advice, when starting use of a bicycle or the like, a message that encourages an increase in the number of steps, such as “Would you like to park your bicycle far away from the building at the bicycle parking lot today?” is presented.

### <Hardware Configuration>

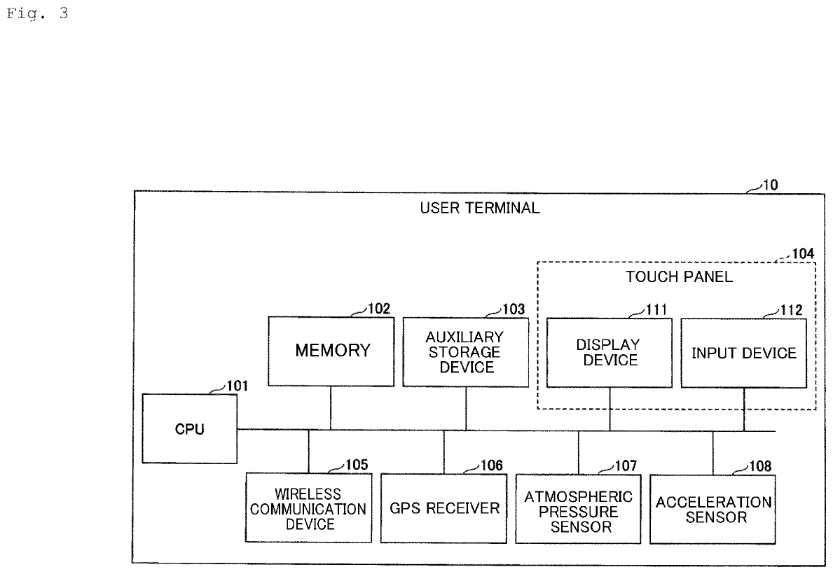

FIG. 3 is a diagram illustrating a hardware configuration example of a user terminal 10 according to the first embodiment. In FIG. 3, the user terminal 10 includes a CPU 101, a memory 102, an auxiliary storage device 103, a touch panel 104, a wireless communication device 105, a GPS receiver 106, an atmospheric pressure sensor 107, an acceleration sensor 108, and the like.

The auxiliary storage device 103 stores programs and the like installed in the user terminal 10. The memory 102 reads out and stores the program from the auxiliary storage device 103 in a case where an instruction to start the program is given. The CPU 101 implements a function of the user terminal 10 in accordance with the program stored in the memory 102.

The touch panel 104 is an electronic component having both an input function and a display function, and displays information, accepts input from a user, and the like. The touch panel 104 includes a display device 111, an input device 112, and the like.

The display device 111 is a liquid crystal display or the like, and serves as a display function of the touch panel 104. The input device 112 is an electronic component including a sensor for detecting contact of a contact object with the display device 111.

The wireless communication device 105 is an electronic component such as an antenna required for communication in a wireless local area network (LAN) or a mobile communication network. The GPS receiver 106 receives a radio wave from a global positioning system (GPS) satellite.

The atmospheric pressure sensor 107 measures (calculates) atmospheric pressure at the user terminal 10.

The acceleration sensor 108 measures information such as inclination and vibration of the user terminal 10 by measuring acceleration of the user terminal 10.

Examples of the user terminal 10 include a smartphone, a tablet type terminal, a wearable device, and the like.

### <Function Configuration>

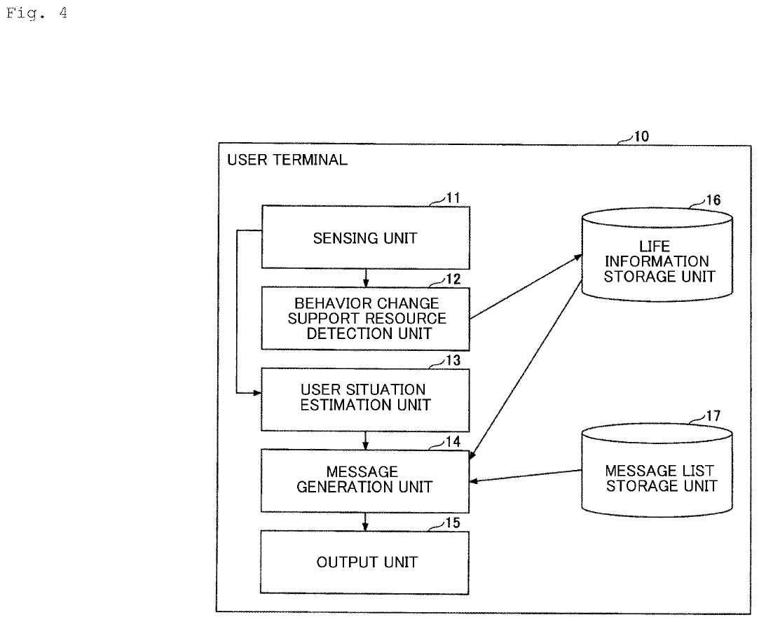

FIG. 4 is a diagram illustrating a functional configuration example of the user terminal 10 in the first embodiment. As illustrated in FIG. 4, the user terminal 10 includes a sensing unit 11, a behavior change support resource detection unit 12, a user situation estimation unit 13, a message generation unit 14, and an output unit 15. Each of these units is realized through processing that one or more programs (for example, add-ons) installed in the user terminal 10 causes the CPU 101 to execute. The user terminal 10 also uses a life information storage unit 16 and a message list storage unit 17. These storage units can be achieved by using, for example, the auxiliary storage device 103, a storage device that can be connected to the user terminal 10 via a network, or the like.

The sensing unit 11 acquires data sensed by the GPS receiver 106, the atmospheric pressure sensor 107, or the acceleration sensor 108 (hereinafter referred to as “sensing data”).

The behavior change support resource detection unit 12 detects the use of behavior change support resources such as stairs, slopes and moving means based on the sensing data. The behavior change support resource detection unit 12 records the kind of the detected behavior change support resource, a start point and an end point of use of the behavior change support resource, etc. in the life information storage unit 16.

The user situation estimation unit 13 estimates a situation of a user such as spatial or temporal approach to the behavior change support resource based on the sensing data.

The message generation unit 14 refers to the message list storage unit 17 and generates a message corresponding to the user situation. The message list storage unit 17 stores a message corresponding to life environments and lifestyles.

The output unit 15 presents (outputs) the message generated by the message generation unit 14.

### <Processing Procedure>

Hereinafter, the processing procedure executed by the user terminal 10 will be described separately into a life information registration phase and a recommended behavior presentation phase.

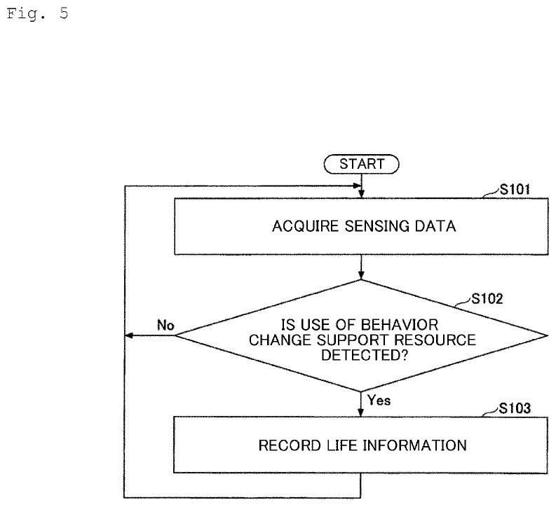

FIG. 5 is a flowchart for illustrating an example of a processing procedure executed by the user terminal 10 in the life information registration phase.

The sensing unit 11 acquires sensing data at every fixed time, for example (S101).

Next, based on the history of sensing data, the behavior change support resource detection unit 12 tries to detect the user's use of behavior change support resources such as elevator use, escalator use, stair use, slope use, automobile/motorcycle use, bicycle use, and the like (S102). The method of detecting the use of the behavior change support resource is as described above.

When detecting the use of any one of the behavior change support resources (Yes in S102), the behavior change support resource detection unit 12 records the type of the behavior change support resource related to the detection and the respective positional information of a start point and an end point such as the use or passage of the behavior change support resource in the life information storage unit 16.

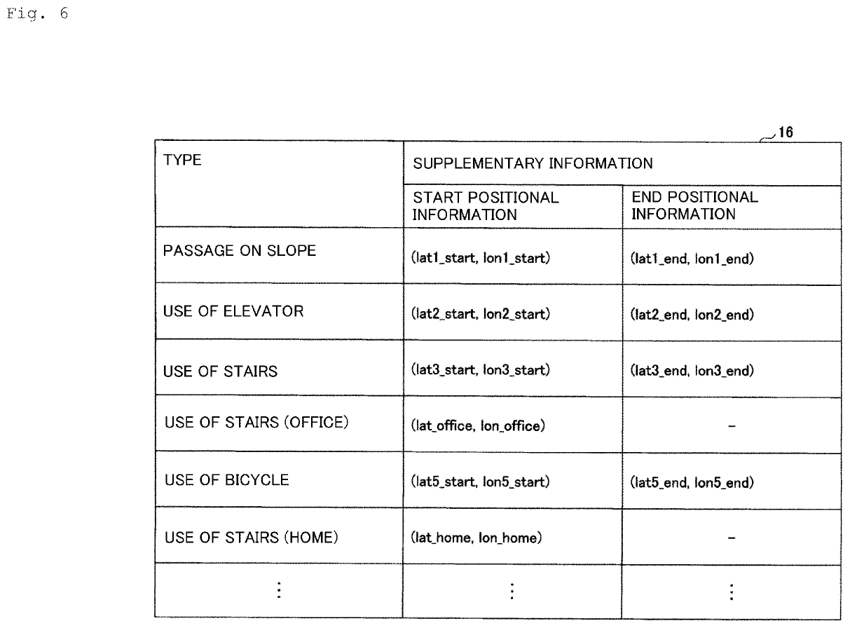

FIG. 6 is a diagram illustrating a configuration example of the life information storage unit 16 in the first embodiment. As illustrated in FIG. 6, each time the behavior change support resource detection unit 12 detects the use of the behavior change support resource, the type of the behavior change support resource, the start positional information and the end positional information related to the behavior change support resource are recorded in the life information storage unit 16. The start positional information is positional information of a start point of use (including passage) of the behavior change support resource. The end positional information is positional information of an end point of use of the behavior change support resource. The positional information items can be acquired from the GPS receiver 106.

In the example illustrated in FIG. 6, the use of stairs in the office and the use of stairs in the home are distinguished from each other. It is assumed that the positional information of the office and the home is registered in advance based on an input by a user, an estimation from a staying time, GPS data, and the like. In a case where the behavior change support resource detection unit 12 detects the use of stairs, elevators, and escalators, it determines whether the current position is at home or in the office based on the GPS data at that time. When the current position is at a home or an office, the behavior change support resource detection unit 12 registers the positional information of the office or the home in the start positional information of the life information storage unit 16. In FIG. 6, (lat_office, lon_office) indicates the positional information of the office, and (lat_home, lon_home) indicates the positional information of the home.

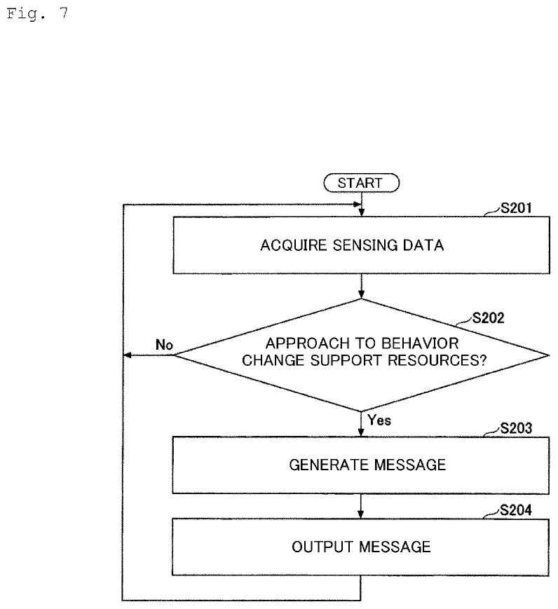

FIG. 7 is a flowchart for illustrating an example of a processing procedure executed by the user terminal 10 in the recommended behavior presentation phase.

The sensing unit 11 acquires sensing data at every fixed time, for example (S201). In the recommended behavior presentation phase, GPS data (positional information) may be acquired.

Each time the sensing unit 11 acquires sensing data (or each time the sensing data changes), the user situation estimation unit 13 determines whether a point related to the positional information indicated by the sensing data is included inside any circle of a radius Dₜₕ centering on the point related to all the start positional information registered in the life information storage unit 16, thereby determining whether the user has approached the behavior change support resource

(S202). That is, the user situation estimation unit 13 calculates a distance between all start positional information registered in the life information storage unit 16 and positional information indicated by the sensing data, and determines the presence or absence of an behavior change support resource whose distance is equal to or less than Dₜₕ, thereby estimating whether the user has approached the behavior change support resource.

However, with respect to the behavior change support resources in the office or the home (“use of stairs (office)” or “use of stairs (home)” illustrated in FIG. 6), there is a possibility that the user is always estimated to approach the behavior change support resources while the user stays in the office or the home. Then, the user situation estimation unit 13 estimates, for an behavior change support resource whose office or home is start positional information, a distance between the behavior change support resource and the current position of the user is equal to or less than Dₜₕ, and when the current time is a certain time t, it is estimated that the user approaches the behavior change support resource.

When the user situation estimation unit 13 estimates the approach to any behavior change support resource (Yes in S202), the message generation unit 14 acquires a message corresponding to the type of the behavior change support resource (that is, behavior change support resource whose distance to the current position is equal to or less than Dₜₕ) from the message list storage unit 17, and generates a message to be presented to the user (S203).

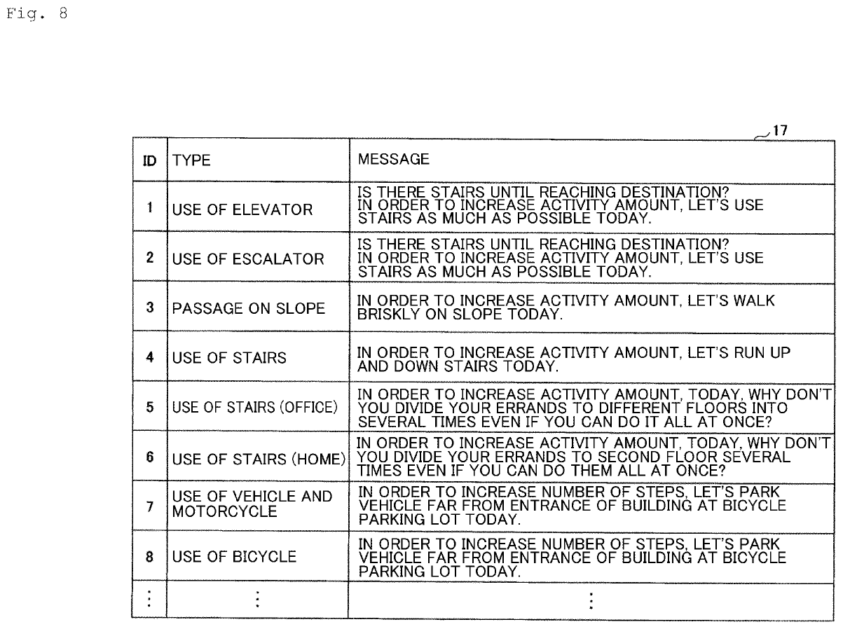

FIG. 8 is a diagram illustrating a configuration example of the message list storage unit 17 according to the first embodiment. As illustrated in FIG. 8, messages are stored in the message list storage unit 17 in association with the type of the behavior change support resource. In the example illustrated in FIG. 8, an example in which a complete message is registered is illustrated, but, for example, a message template may be stored in the message list storage unit 17 to which the user's name or the like can be substituted. In this case, the message generation unit 14 may generate a message using the template.

Subsequently, the output unit 15 outputs the message generated (acquired) by the message generation unit 14 to, for example, the display device 111 (S204). Alternatively, the output unit 15 may output the message in voice.

The approach to the behavior change support resource may be estimated by using a sensor mounted on a mobility and a key of an automobile or the like instead of positional information by the GPS.

Further, since circles having the radius Dₜₕ overlap each other or circles are close to each other, there is a possibility that a plurality of messages are output at a time or messages are frequently output. However, measures such as giving priority to messages and setting the frequency of message presentation are conceivable.

In addition, even if the use of an elevator or escalator is detected, there may be cases where there are no stairs nearby, or cases where there are stairs nearby but cannot normally be used due to emergency stairs. However, in that case, the user situation estimation unit 13 may be excluded from the user's approach estimation target for the behavior change support resource in which the use of the stairs is not detected multiple times after the message is output and it accepts inputs such as “there are no stairs nearby” from the user via a GUI (Graphical User Interface). Thus, when the user approaches the behavior change support resource thereafter, the same message can be prevented from being output.

Further, although it is considered that the contents of the message need to be changed between the case where the center of the living space (living room or the like) is the first floor and the case where the center is the second floor, the center floor of the living space may be determined by sensing and adjusted according to the result.

As described above, according to the first embodiment, it is possible to automatically grasp the life information that can be utilized in supporting the behavior change without requiring the user to answer questions, questionnaires, and the like. Further, the practice rate of the recommended behavior can be increased by grasping life information which can be utilized in supporting the behavior change and then notifying the recommended behavior based on the life information. Therefore, the efficiency of the behavior change support can be improved.

### Second Embodiment

Next, a second embodiment will be described. In the second embodiment, differences from the first embodiment will be described. Points which are not mentioned particularly in the second embodiment may be similar to those of the first embodiment.

The second embodiment is an embodiment relating to presentation of a message to improve eating habits of lunch.

In order to improve eating habits, it is considered that advice is presented about the contents of meals, but it is difficult to change the contents of meals even if the advice is presented after the contents of meals have been determined, and it is considered that the practice rate of recommended behaviors is lowered.

When the advice is presented immediately before the meal content is determined, the user can change the meal content, so that it is considered that the timing of determining the meal content is grasped as a resource which can be utilized for improving the eating habit.

The timing at which the meal content is determined differs depending on the form of the lunch. Therefore, in the second embodiment, the form of the lunch is grasped as a behavior change support resource. The following examples are conceivable as the form of lunch.
Lunch form 1: The food is purchased at a convenience store or a store and eaten at a user's seat or a rest room.
Lunch form 2: The lunch box is brought from a home and eaten in a user's seat or a rest room.
Lunch form 3: Eat in the staff cafeteria.
Lunch form 4: Go out and have lunch outside.

It is considered that the advice for promoting the improvement of the meal content is effectively presented at a timing before the meal content is determined and at a timing close to a time point when the meal content is determined to such an extent that the advice is not forgotten. Therefore, in the second embodiment, the message is presented at the following timing according to the lunch form.

In the case of Lunch Form 1, it is desirable to notify the advice before purchasing the lunch in a convenience store or a store, and therefore, when it is grasped from GPS data or the like that the user has entered the convenience store or the store, push notification is performed and a message is presented.

In the case of Lunch Form 2, since there is a possibility that the content of the next day lunch is considered at the time of dinner the day before, for example, push notification is performed at the time of detecting a behavior such as preparation of the evening rice from a sensor installed in a refrigerator or the like in a house, and a message is presented.

In the case of Lunch Form 3 or Lunch Form 4, a beacon or the like installed on the door of the office room in an office detects that the person has passed through the door 30 minutes before or after the start of the lunch break.

Referring to FIG. 5, the processing procedure executed by the user terminal 10 in the life information registration phase of the second embodiment will be described.

The sensing unit 11 acquires sensing data at every fixed time, for example (S101). In this case, positional information such as GPS data or data such as indoor position measurement may be acquired.

Then, the behavior change support resource detection unit 12 tries to detect the use of the behavior change support resource (lunch form) based on the history of the sensing data (S102).

For example, in the case where residence in a convenience store, a store or the like is detected in an attendance time period or a day rest time zone, and residence in a user's seat, a rest room or the like is detected in a day rest time zone, it is estimated that the user is eating the purchased food in the user's seat, the rest room or the like. Therefore, in this case, the behavior change support resource detection unit 12 detects the use of the lunch form 1.

Alternatively, in a history of sensing data in an attendance time zone or a time zone of a day rest, when residence in a convenience store or a store is not detected and residence in a user's seat or a rest room is detected in the time zone of the day rest, it is estimated that the user is eating the prepared one at home. Therefore, in this case, the behavior change support resource detection unit 12 detects the use of Lunch Form 2.

Alternatively, when the stay in the employee restaurant is detected in the history of sensing data in the time zone of the day rest, it is estimated that the user is eating the lunch in the staff cafeteria. Therefore, in this case, the behavior change support resource detection unit 12 detects the use of Lunch Form 3.

Alternatively, when the stay in a restaurant outside the company is detected in a history of sensing data in a time zone of a day rest, it is estimated that the user is going out of the company and eating out of the company in the day. Therefore, in this case, the behavior change support resource detection unit 12 detects the use of Lunch Form 4.

It is assumed that the positional information of the convenience store, the store, the staff cafeteria, and the restaurant outside the company is registered in advance. Therefore, the behavior change support resource detection unit 12 can detect the stay of the user at these places by collating the positional information with the history of the sensing data.

When the behavior change support resource detection unit 12 detects the use of any of Lunch Forms 1 to 4 (Yes in S102), the behavior change support resource detection unit 12 records the kind of the lunch form related to the detection in the life information storage unit 16.

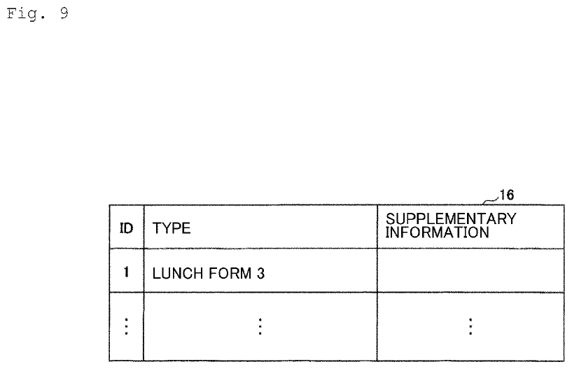

FIG. 9 is a diagram illustrating a configuration example of the life information storage unit 16 according to the second embodiment. As illustrated in FIG. 9, the life information storage unit 16 of the second embodiment records the type of the lunch form whose use is detected by the behavior change support resource detection unit 12.

Next, the processing procedure executed by the user terminal 10 in the recommended behavior presentation phase of the second embodiment will be described with reference to FIG. 7. In the recommended behavior presentation phase of the second embodiment, the user terminal 10 senses the positional information of the user, the home behavior, and the like, and presents the message at a timing matched to the type of the behavior change support resource (that is, the lunch form) registered in the life information storage unit 16.

The sensing unit 11 acquires sensing data at every fixed time, for example (S201). In this case, positional information such as GPS data or data such as indoor position measurement may be acquired.

Subsequently, the user situation estimation unit 13 determines whether the user approaches the lunch form registered in the life information storage unit 16 based on the history of the sensing data or the like (S202).

Specifically, in a case where Lunch Form 1 is registered in the life information storage unit 16, the user situation estimation unit 13 estimates the approach to Lunch Form 1 at the timing of detecting that the user enters a convenience store, a store or the like from GPS data or the like.

Alternatively, when Lunch Form 2 is registered in the life information storage unit 16, the user situation estimation unit 13 senses opening/closing of a door of the refrigerator by communication with the refrigerator in which an acceleration sensor or the like in a house is installed, the approach to Lunch Form 2 is estimated at the timing when it is detected that the refrigerator has been opened and closed after 17:00 in the evening.

Alternatively, when Lunch Form 3 or Lunch Form 4 is registered in the life information storage unit 16, the user situation estimation unit 13 senses passage of a user's door based on a beacon or the like installed in a door of a living room in an office, the approach to Lunch Form 3 or Lunch Form 4 is estimated at the timing when passing through the door from the living room to the outside was detected 30 minutes before and after the lunch break start time.

When the user situation estimation unit 13 estimates approach to any lunch form (Yes in S202), the message generation unit 14 acquires a message corresponding to the lunch form from the message list storage unit 17 and generates a message to be presented to the user (S203).

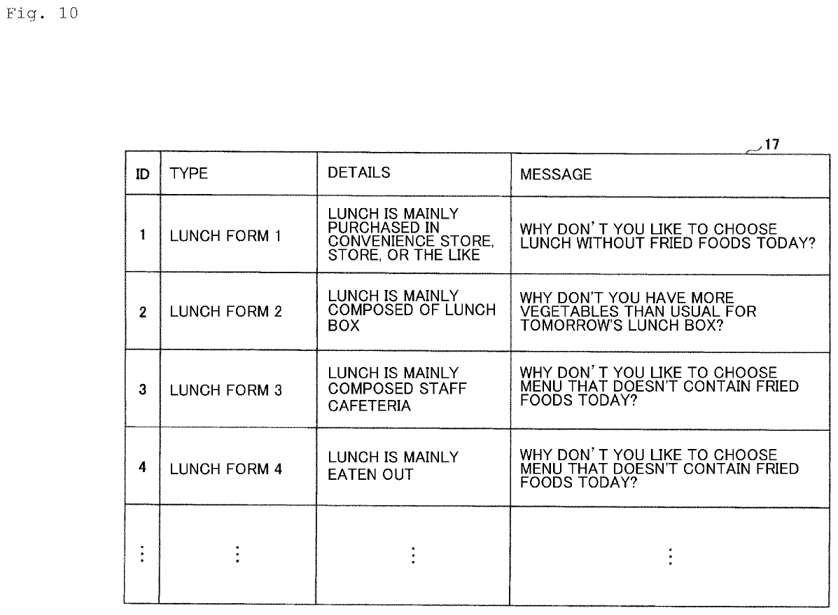

FIG. 10 is a diagram illustrating a configuration example of the message list storage unit 17 according to the second embodiment. As illustrated in FIG. 10, messages are stored in the message list storage unit 17 in association with the type of the lunch form.

Then, the output unit 15 outputs the message generated (acquired) by the message generation unit 14 by push notification (S204). For example, the output unit 15 may output the message to the display device 111 or may output a voice.

Although a possibility that a plurality of types of lunch forms are registered in the life information storage unit 16 is considered (lunch once every week, and others are the staff cafeteria and the like), in that case, the system learns and predicts periodicity from the result of sensing to present advice, the adjustment may be performed by narrowing down advice to the form of the lunch with the highest frequency of appearance.

As described above, according to the second embodiment, effects similar to those of the first embodiment can be obtained.

The second embodiment is particularly concerned with improving the content of meals for lunch. In addition to this, sensing is used to grasp when the behavior to be improved is determined, and the behavior to be improved may be anything other than eating as long as the advice prompting the improvement of the behavior is presented at a timing before the point in time when the behavior targeted for improvement is decided and at a timing close to the point at which the behavior is determined so as not to forget the advice.

In each of the above embodiments, the behavior change support resource detection unit 12, the user situation estimation unit 13, and the message generation unit 14 are one or more computers different from the user terminal 10, The present invention may be implemented by a computer (for example, cloud computing) capable of communicating with a user terminal 10.

In this embodiment, the user terminal 10 is an example of the behavior change support device. The behavior change support resource detection unit 12 is an example of a detection unit. The user situation estimation unit 13 is an example of an estimation unit. The life information storage unit 16 is an example of a storage unit.

Although the embodiments of the present invention have been described in detail above, the present invention is not limited to these particular embodiments, and various modifications and changes are possible within the scope of the gist of the present invention described in the claims.

### REFERENCE SIGNS LIST

| | |
|---|---|
| 10 | User terminal |
| 11 | Sensing unit |
| 12 | Behavior change support resource detection unit |
| 13 | User situation estimation unit |
| 14 | Message generation unit |
| 15 | Output unit |
| 16 | Life information storage unit |
| 17 | Message list storage unit |
| 101 | CPU |
| 102 | Memory |
| 103 | Auxiliary storage device |
| 104 | Touch panel |
| 105 | Wireless communication device |
| 106 | GPS receiver |
| 107 | Atmospheric pressure sensor |
| 108 | Acceleration sensor |
| 111 | Display device |
| 112 | Input device |

1. A behavior change support method executed by a computer including a memory and a processor, the behavior change support method comprising:
recording information on a resource in the memory when detecting use of the resource that can be utilized for supporting behavior change of a user based on sensing data;
estimating a spatial or temporal approach of a user to the resource indicated by the information recorded in the memory based on the sensing data; and
outputting a message corresponding to the resource to which the approach of the user is estimated.

2. The behavior change support method according to claim 1, wherein the resource is a resource that increases an activity amount of the user.

3. The behavior change support method according to claim 1, wherein the resource is in a form of a meal of the user.

4. A behavior change support device comprising:
a memory; and
a processor configured to:
record information on a resource in the memory when detecting use of the resource that can be utilized for supporting behavior change of a user based on sensing data;
estimate a spatial or temporal approach of a user to the resource indicated by the information recorded in the memory based on the sensing data; and
output a message corresponding to the resource to which the approach of the user is estimated.

5. The behavior change support device according to claim 4, wherein the resource is a resource that increases an activity amount of the user.

6. The behavior change support device according to claim 4, wherein the resource is in a form of a meal of the user.

7. (canceled)

8. A non-transitory computer-readable recording medium having computer-readable instructions stored thereon, which, when executed, cause a computer to execute a method, the method comprising:
recording information on a resource in a memory when detecting use of the resource that can be utilized for supporting behavior change of a user based on sensing data;
estimating a spatial or temporal approach of a user to the resource indicated by the information recorded in the memory based on the sensing data; and
outputting a message corresponding to the resource to which the approach of the user is estimated.
